(19) United States
(12) Patent Application Publication
(10) Pub. No.: US 2025/0317845 A1
(43) Pub. Date: Oct. 9, 2025

(54) BACKHAUL SIGNALING TO SUPPORT NETWORK ENERGY SAVING

(71) Applicant: QUALCOMM Incorporated, San Diego, CA (US)

(72) Inventors: Naeem AKL, Bridgewater, NJ (US); Navid ABEDINI, Basking Ridge, NJ (US); Karl Georg HAMPEL, Jersey City, NJ (US)

(21) Appl. No.: 18/626,093

(22) Filed: Apr. 3, 2024

(51) Int. Cl. H04W 52/02; H04W 48/08; H04W 48/16

(52) U.S. Cl. CPC H04W 52/0206; H04W 48/08; H04W 48/16

(57) ABSTRACT

Various aspects of the present disclosure generally relate to wireless communication. Some aspects relate to backhaul signaling to support network energy saving (NES) cell operating in an NES mode. In some aspects, a network node associated with an NES cell may transmit, via backhaul signaling, information associated with an NES mode of the NES cell. The NES cell may operate in the NES mode and may communicate with a user equipment (UE) in accordance with the NES mode. In some aspects, a network node associated with an anchor cell may receive information associated with the NES mode of the NES cell. The anchor cell may transmit assistance information to enable the UE to access the NES cell in accordance with the NES mode.

### FIELD OF THE DISCLOSURE

Aspects of the present disclosure generally relate to wireless communication and specifically relate to techniques, apparatuses, and methods associated with backhaul signaling to support network energy saving.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

For various reasons, including climate change mitigation, environmental sustainability, and network cost reduction, network energy saving and/or network energy efficiency measures are expected to have increased importance in wireless network operations. For example, although NR generally offers a significant energy efficiency improvement per gigabyte over previous generations (for example, LTE), new NR use cases and/or the adoption of millimeter wave frequencies may require more network sites, more network antennas, larger bandwidths, and/or more frequency bands, which could potentially lead to more efficient wireless networks that nonetheless have higher energy requirements and/or cause more emissions than previous wireless network generations. Furthermore, energy accounts for a significant proportion of the cost to operate a wireless network. For example, according to some estimates, energy costs are about one-fourth of the total cost to operate a wireless network. The largest proportion of energy consumption and/or energy costs are associated with a radio access network (RAN), which accounts for about half of the energy consumption in a wireless network, with data centers and fiber transport accounting for smaller shares. Accordingly, measures to increase network energy savings and/or improve network energy efficiency are important factors that may drive adoption and/or expansion of wireless networks.

### SUMMARY

Some aspects described herein relate to a network node for wireless communication. The network node may include a processing system that includes one or more processors and one or more memories coupled with the one or more processors. The processing system may be configured to cause the network node to transmit, via backhaul signaling, information associated with a network energy saving (NES) mode of an NES cell. The processing system may be configured to cause the network node to communicate with a user equipment (UE) via the NES cell in accordance with the NES mode.

Some aspects described herein relate to a network node for wireless communication. The network node may include a processing system that includes one or more processors and one or more memories coupled with the one or more processors. The processing system may be configured to cause the network node to receive, via backhaul signaling, information associated with an NES mode of an NES cell. The processing system may be configured to cause the network node to transmit, via an anchor cell, assistance information to enable a UE to access the NES cell in accordance with the NES mode.

Some aspects described herein relate to a method for wireless communication by a network node associated with an NES cell. The method may include transmitting, via backhaul signaling, information associated with an NES mode of the NES cell. The method may include communicating with a UE via the NES cell in accordance with the NES mode.

Some aspects described herein relate to a method for wireless communication by a network node associated with an anchor cell. The method may include receiving, via backhaul signaling, information associated with an NES mode of an NES cell. The method may include transmitting, via the anchor cell, assistance information to enable a UE to access the NES cell in accordance with the NES mode.

Some aspects described herein relate to a non-transitory computer-readable medium that stores a set of instructions for wireless communication by a network node associated with an NES cell. The set of instructions, when executed by one or more processors of the NES, may cause the NES to transmit, via backhaul signaling, information associated with an NES mode of the NES cell. The set of instructions, when executed by one or more processors of the NES, may cause the NES to communicate with a UE via the NES cell in accordance with the NES mode.

Some aspects described herein relate to a non-transitory computer-readable medium that stores a set of instructions for wireless communication by a network node associated with an anchor cell. The set of instructions, when executed by one or more processors of the network node associated with an anchor cell, may cause the network node associated with an anchor cell to receive, via backhaul signaling, information associated with an NES mode of an NES cell. The set of instructions, when executed by one or more processors of the network node associated with an anchor cell, may cause the network node associated with an anchor cell to transmit, via the anchor cell, assistance information to enable a UE to access the NES cell in accordance with the NES mode.

Some aspects described herein relate to an apparatus for wireless communication. The apparatus may include means for transmitting, via backhaul signaling, information associated with an NES mode of an NES cell. The apparatus may include means for communicating with a UE via the NES cell in accordance with the NES mode.

Some aspects described herein relate to an apparatus for wireless communication. The apparatus may include means for receiving, via backhaul signaling, information associated with an NES mode of an NES cell. The apparatus may include means for transmitting, via an anchor cell, assistance information to enable a UE to access the NES cell in accordance with the NES mode.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network in accordance with the present disclosure.

FIG. 2 is a diagram illustrating an example network node in communication with an example user equipment (UE) in a wireless network in accordance with the present disclosure.

FIG. 3 is a diagram illustrating an example disaggregated base station architecture in accordance with the present disclosure.

FIG. 4 is a diagram illustrating examples of network energy saving (NES) scenarios in accordance with the present disclosure.

FIG. 5 is a diagram illustrating examples of anchor cell and NES cell deployments in accordance with the present disclosure.

FIG. 6 is a diagram of an example associated with backhaul signaling to support NES, in accordance with the present disclosure.

FIG. 7 is a flowchart illustrating an example process performed, for example, at a network node or an apparatus of a network node associated with an NES cell in accordance with the present disclosure.

FIG. 8 is a flowchart illustrating an example process performed, for example, at a network node or an apparatus of a network node associated with an anchor cell in accordance with the present disclosure.

FIG. 9 is a diagram of an example apparatus for wireless communication that supports backhaul signaling to support NES in accordance with the present disclosure.

FIG. 10 is a diagram of an example apparatus for wireless communication that supports backhaul signaling to support NES in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

A network energy saving (NES) cell is a cell, in a wireless communication network, that operates in an NES mode. An NES mode is a mode of operation for a cell that reduces energy consumption by the cell as compared with a normal mode of operation for cells in the wireless communication. In some examples, an anchor cell may be associated with an NES cell. An anchor cell is a cell that supports the NES cell when the NES cell is operating in an NES mode. For example, the anchor cell may be a cell that provides assistance information (for example, to a user equipment (UE) or multiple UEs) in relation to an NES technique (for example, the NES mode) applied on another cell (for example, the NES cell). In some examples, an NES mode of an NES cell may be an on-demand system information block (SIB) type 1 (SIB1) mode. When operating in the on-demand SIB1 mode, the NES cell May broadcast periodic SIB1 transmissions or may broadcast periodic SIB 1 transmissions less frequently (as compared with a normal mode of operation). An idle or inactive UE may receive a wake-up signal (WUS) configuration from the anchor cell associated with the NES cell, and the idle or inactive UE may transmit a WUS toward the NES cell in accordance with the WUS configuration. The NES cell may begin transmitting the SIB1 or begin transmitting the SIB1 more frequently in response to receiving the WUS. In some other examples, an NES mode of an NES cell may be an SIB1-less mode. When operating in the SIB1-less mode, the NES cell does not transmit the SIB1. An idle or inactive UE may receive the SIB1 of the NES cell from the anchor cell associated with the NES cell, and the idle or inactive UE may access the NES cell directly based on or otherwise associated with the SIB1 of the NES that is received from the anchor cell. Such NES modes may reduce network energy consumption by reducing periodic transmissions by the NES cell. However, backhaul support to enable such NES modes has not yet been established.

Various aspects relate generally to backhaul signaling to support an NES cell operating in an NES mode. Some aspects more specifically relate to backhaul signaling to enable an NES mode of operation for an NES cell and to share configuration information associated with the NES mode of operation. In some aspects, a network node associated with an NES cell may transmit, via backhaul signaling, information associated with an NES mode of the NES cell. In some examples, the network node associated with the NES cell may be a distributed unit (DU) that hosts the NES cell, and the DU may transmit the information to a central unit (CU). In some other examples, the network node associated with the NES cell may be a gNB, and the gNB may transmit the information to another gNB associated with an anchor cell. In some aspects, a network node associated with an anchor cell may receive information associated with the NES mode of the NES cell. In some examples, the network node associated with the anchor cell may be a DU that hosts the anchor cell, and the DU may receive the information from a CU. For example, the DU that hosts the anchor cell may receive the information from the same CU that receives the information transmitted by the DU that hosts the NES cell. In some other examples, the network node associated with the NES cell may be a gNB, and the gNB associated with the anchor cell may receive the information from the gNB associated with a NES cell. The anchor cell may transmit assistance information to enable a UE to access the NES cell in accordance with the NES mode. The NES cell may operate in the NES mode and may communicate with the UE in accordance with the NES mode.

In some examples, the information transmitted by the network node associated with the NES cell may include information associated with activating the NES cell to operate in the NES mode. In some examples, the information received by the network node associated with the anchor cell may include information indicating the NES cell and the NES mode, and information associated with activating the anchor cell to operate in an anchor mode for the NES cell. In some examples, the information transmitted by the network node associated with the NES cell and the information received by the network node associated with the anchor cell may include NES configuration information, associated with the NES mode, that is to be transmitted via the anchor cell. In such examples, the network node associated with the anchor cell may include the NES configuration information in the assistance information transmitted via the anchor cell. In one example, the NES mode may be an on-demand SIB 1 mode, and the NES configuration information may include a WUS configuration and a post-demand SIB1 transmission configuration associated with the NES cell. In another example, the NES mode may be an SIB1-less mode, and the NES configuration may include system information, such as an SIB1, associated with the NES cell. In some examples, the information transmitted by the network node associated with the NES cell and/or the information received by the network node associated with the anchor cell may include beam-specific information.

Particular aspects of the subject matter described in this disclosure can be implemented to realize one or more of the following potential advantages. In some examples, by transmitting information associated with an NES mode of an NES cell from a network node associated with the NES cell via backhaul signaling and receiving information associated with the NES mode of the NES cell at a network node associated with the NES cell via backhaul signaling the described techniques can be used to enable the NES cell to operate in the NES mode, which may increase network energy savings and improve network energy efficiency. In some examples, by transmitting information associated with the NES mode of the NES cell from a DU hosting the NES cell to a CU and receiving information associated with the NES mode of the NES cell at a DU hosting the anchor cell from a CU (for example, the same CU that receives the information transmitted by the DU hosting the NES cell), the described techniques can be used to enable the NES cell to operate in the NES mode in a deployment in which the anchor cell and the NES cell are served by DUs (for example, different DUs or the same DU) associated with the same CU (DUs of the same gNB). In some examples, by transmitting information associated with the NES mode of the NES cell from a gNB associated with the NES cell to another gNB associated with the anchor cell, the described techniques can be used to enable the NES cell to operate in the NES mode in a deployment in which the anchor cell and the NES cell are served by different gNBs.

In some examples, by the network node associated with the NES cell transmitting, via backhaul signaling, information associated with activating the NES cell to operate in the NES mode, the described techniques can be used to activate the NES cell to operate in the NES mode, which may result in increased network energy savings and improved network energy efficiency. In some examples, by the network node associated with the anchor cell receiving, via backhaul signaling, information indicating the NES cell and the NES mode, and information associated with activating the anchor cell to operate in an anchor mode for the NES cell, the described techniques can be used to select and activate the anchor cell to provide support for the NES cell operating in NES mode, which may result in an overall increase in network energy savings. In some examples, by the network node associated with the NES cell transmitting NES configuration information via backhaul signaling, and the network node associated with the anchor cell receiving the NES configuration information via backhaul signaling, the described techniques can be used to provide backhaul support for sharing configuration information for the NES mode between the NES cell and the anchor cell to enable the NES cell to operate in the NES mode and the anchor cell to support the NES cell operating in the NES mode. In some examples, by including the NES configuration information in the assistance information transmitted via the anchor cell, the describe technique can be used to enable a UE to access the NES cell while the NES cell is operating in the NES mode, which results in improved network coverage and increased network energy savings.

In some examples, by including a WUS configuration and a post-demand SIB1 transmission configuration in the NES configuration information associated with an on-demand SIB1 mode, the described techniques can be used to enable the NES cell to operate in the on-demand SIB1 mode, which may result in increased network energy savings due to the NES cell transmitting SIB1 less frequently as compared with periodic transmissions in a normal operating mode. In some examples, by including system information, such as an SIB1, associated with the NES cell in the NES configuration information, the described techniques can be used to enable the NES cell to operate in an SIB1-less mode, which may result in increased network energy savings due to the NES cell refraining from transmitting SIB1. In some examples, by the information transmitted by the network node associated with the NES cell and/or the information received by the network node associated with the anchor cell including beam-specific information, the described techniques can be used to enable beam-specific NES mode operation by the NES cell and/or beam-specific anchor mode operation by the anchor cell, which may result in increased flexibility for achieving network energy savings.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

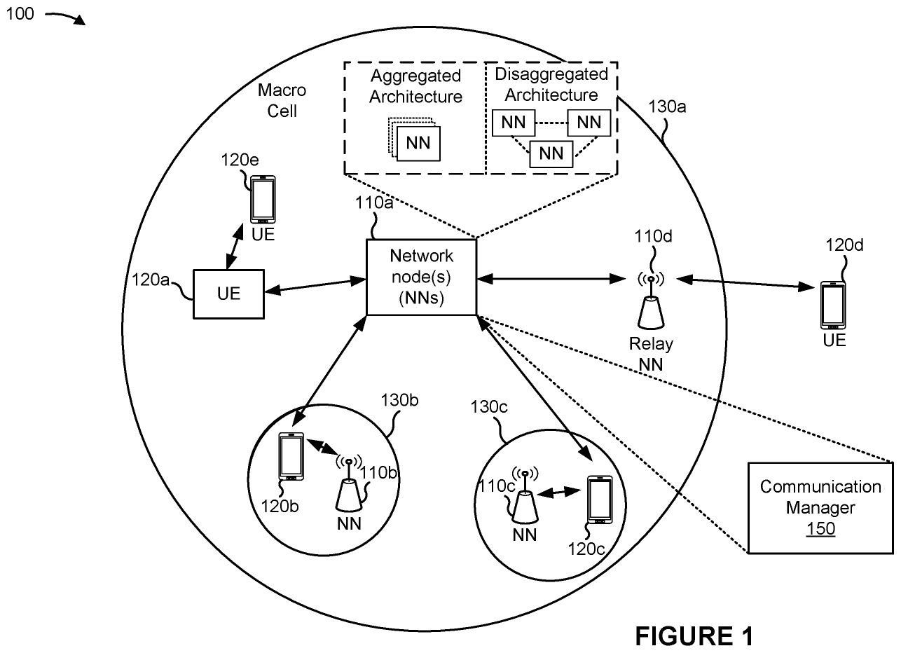

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120e.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHZ), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHZ), and FR5 (114.25 GHz through 300 GHz). Although a portion of FR1 is greater than 6 GHz, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHZ,” if used herein, may broadly refer to frequencies that are less than 6 GHZ, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/LTE and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more CUs, one or more DUs, and/or one or more radio units (RUs). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”. An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, enhanced mobile broadband (eMBB), and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120e) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, the network node 110 may include a communication manager 150. As described in more detail elsewhere herein, the communication manager 150 may transmit, via backhaul signaling, information associated with an NES mode of the NES cell; and communicate with a UE via the NES cell in accordance with the NES mode.

Additionally or alternatively, as described in more detail elsewhere herein, the communication manager 150 may receive, via backhaul signaling, information associated with an NES mode of an NES cell; and transmit, via the anchor cell, assistance information to enable a UE to access the NES cell in accordance with the NES mode. Additionally, or alternatively, the communication manager 150 may perform one or more other operations described herein.

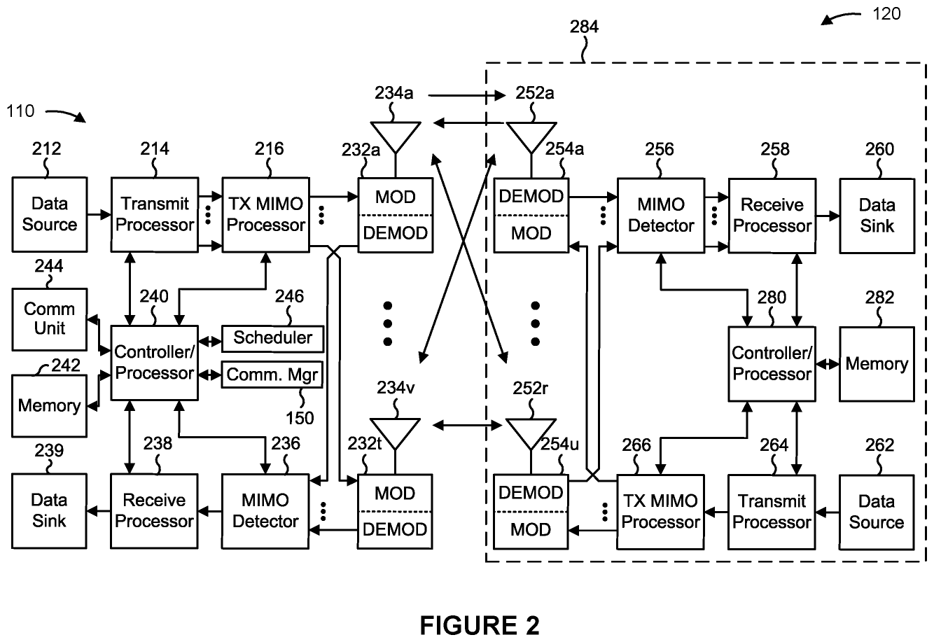

FIG. 2 is a diagram illustrating an example network node 110 in communication with an example UE 120 in a wireless network in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, and/or a memory 282, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

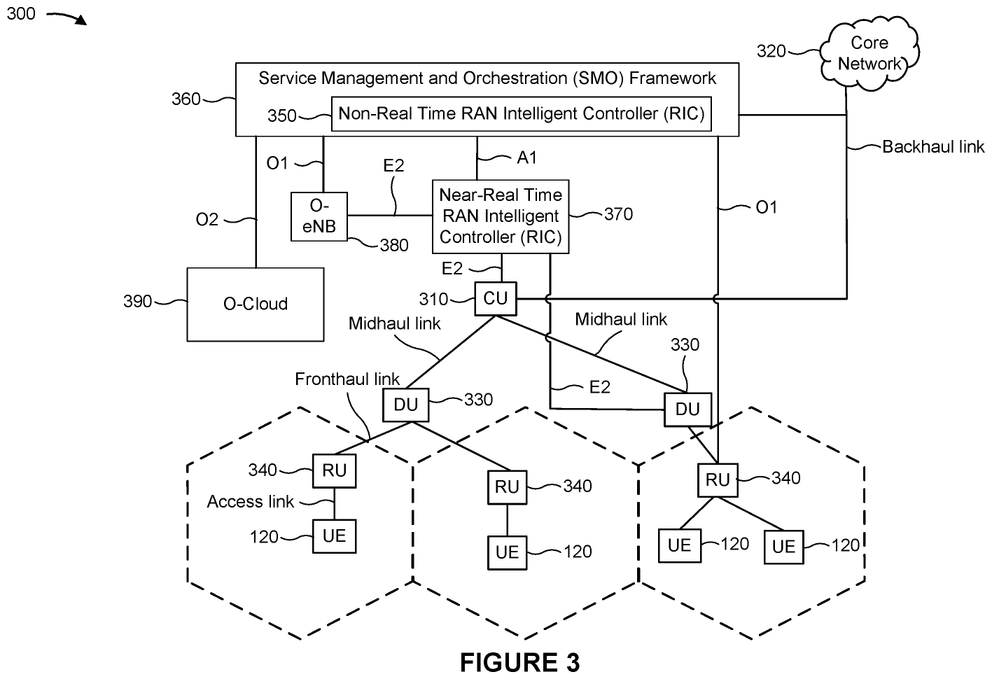

FIG. 3 is a diagram illustrating an example disaggregated base station architecture 300 in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

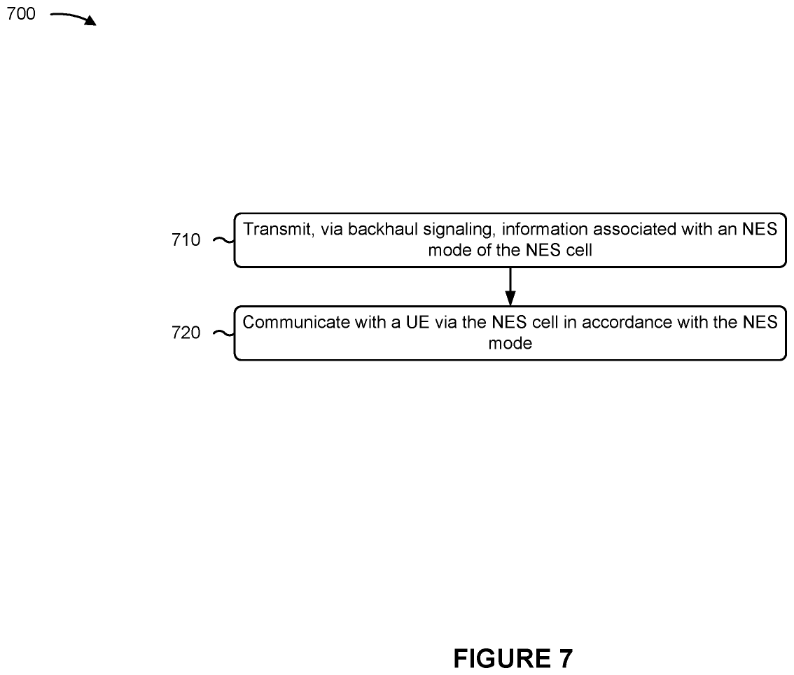

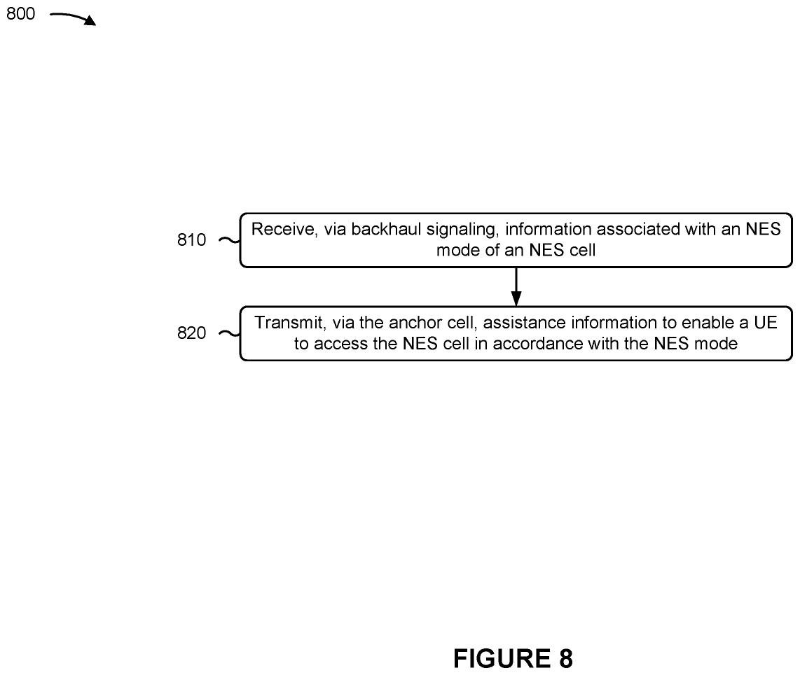

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with backhaul signaling to support NES, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, process 700 of FIG. 7, process 800 of FIG. 8, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 700 of FIG. 7, process 800 of FIG. 8, or other processes as described herein. In some examples, executing instructions may include running the instructions, converting the instructions, compiling the instructions, and/or interpreting the instructions, among other examples.

In some aspects, a network node (for example, the network node 110, the CU 310, the DU 330, or the RU 340) includes means for transmitting, via backhaul signaling, information associated with an NES mode of the NES cell; and/or means for communicating with a UE via the NES cell in accordance with the NES mode.

In some aspects, a network node (for example, the network node 110, the CU 310, the DU 330, or the RU 340) includes means for receiving, via backhaul signaling, information associated with an NES mode of an NES cell; and/or means for transmitting, via the anchor cell, assistance information to enable a UE to access the NES cell in accordance with the NES mode. The means for the network node to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

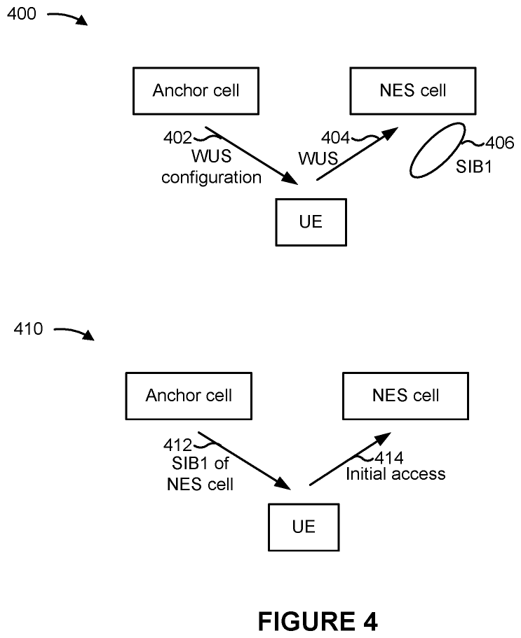

FIG. 4 is a diagram illustrating examples 400 and 410 of NES scenarios in accordance with the present disclosure.

Example 400 shows an example of an on-demand SIB1 scenario. As shown, the on-demand SIB1 scenario may include an NES cell operating in an on-demand SIB1 mode and an anchor cell associated with the NES cell. The anchor cell may provide assistance information in relation to an NES technique (for example, the on-demand SIB1 mode) applied on the NES cell. In some examples, the anchor cell may be associated with a first frequency band (for example, FR1) and the NES cell may be associated with a second frequency band (for example, FR2). In some examples, the on-demand SIB1 mode may be an NES mode (or NES technique) in which the NES cell does not transmit/broadcast periodic SIB 1 transmissions, and instead transmits/broadcasts SIB1 in response to receiving a WUS. In some other examples, the on-demand SIB1 mode may be an NES mode in which the NES cell transmits/broadcasts SIB1 less frequently as compared with periodic SIB1 transmissions in a normal (for example, non-NES) operating mode. In such an example, this NES mode, NES mode in which the NES cell transmits/broadcasts SIB1 less frequently, may be referred to as a “hybrid on-demand SIB1 mode.”

As shown in example 400, in a first operation 402, the anchor cell may transmit, and a UE may receive, a WUS configuration associated with the NES cell. For example, an idle or inactive UE (for example, a UE in an RRC idle or RRC inactive state) may receive the WUS configuration associated with the NES cell from the anchor cell while camping on the anchor cell. In a second operation 404, the UE (for example, the idle or inactive UE) may transmit a WUS toward the NES cell in accordance with the WUS configuration. For example, the UE may transmit the WUS toward the NES cell in a WUS occasion based on or otherwise associated with the WUS configuration. In a third operation 406, the NES cell may transmit the SIB 1 in connection with receiving the WUS in the WUS occasion. For example, the NES cell may broadcast the SIB 1 in response to receiving the WUS. In some examples, the NES cell may begin transmitting the SIB1 in response to receiving the WUS or the NES cell may begin transmitting the SIB1 more frequently in response to receiving the WUS (for example, in the hybrid on-demand SIB1 mode). The UE may receive the SIB 1 transmitted by the NES cell and perform initial access to establish a connection with the NES cell based on or otherwise associated with the system information including in the SIB1.

Example 410 shows an example of an SIB1-less scenario. In the SIB1-less scenario, the NES cell does not transmit SIB1. As shown in example 410, in a first operation 412, the anchor cell may transmit, and a UE may receive, the SIB1 associated with the NES cell. For example, an idle or inactive UE (for example, a UE in an RRC idle or RRC inactive state) may receive the SIB1 associated with the NES cell from the anchor cell. In some examples, the SIB1 associated with the NES cell may be included in system information of the anchor cell. For example, the SIB1 associated with the NES cell may be included in an SIB of the anchor cell that is broadcast by the anchor cell or in an SIB of the anchor cell that is transmitted to the UE on-demand by the anchor cell. In a second operation 414, the UE may perform initial access with the NES cell based on or otherwise associated with the SIB1 associated with the NES cell that is received via the anchor cell. For example, the idle or inactive UE may access the NES cell directly to establish a connection with the NES cell based on or otherwise associated with the system information included in the SIB1 associated with the NES cell that is received via the anchor cell.

In both the on-demand SIB1 scenario and the SIB1-less scenario, there may be sharing of configuration information (for example, the WUS configuration in the on-demand SIB1 scenario and the SIB 1 associated with the NES cell in the SIB1-less scenario) between the NES cell and the anchor cell. Such NES scenarios may require backhaul support to enable the NES mode of operation (for example, the on-demand SIB-1 mode or the SIB1-less mode) and to share the configuration information associated with the NES mode of operation.

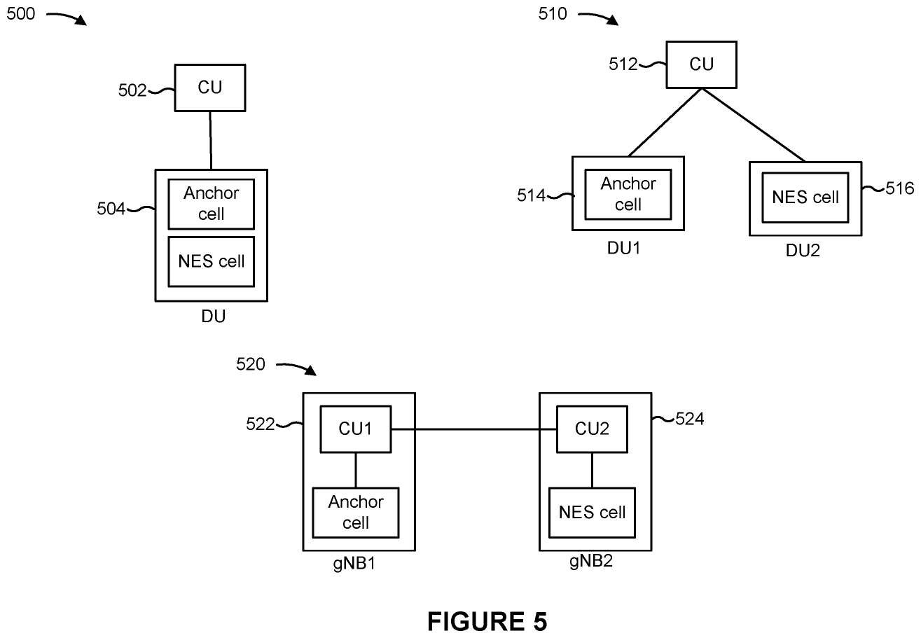

FIG. 5 is a diagram illustrating examples 500, 510, and 520 of anchor cell and NES cell deployments in accordance with the present disclosure. Each of the deployments shown in FIG. 5 includes a NES cell and an anchor cell associated with the NES cell. The NES cell may be operating in an NES mode, such as the on-demand SIB1 mode, the hybrid on-demand SIB 1 mode, the SIB1-less mode, or another NES mode. The anchor cell may provide (for example, to one or more UEs) assistance information relating to the NES mode of the NES cell.

Example 500 shows a first deployment. As shown in example 500, the first deployment includes a CU 502 and a DU 504 that hosts the anchor cell and the NES cell. That is, in the first deployment, the anchor cell may be the NES cell are served by the same DU 504 (for example, a gNB-DU). In some examples, the CU 502 and the DU 504 may communicate via an F1 interface.

Example 510 shows a second deployment. As shown in example 510, the second deployment includes a CU 512, a first DU (DU1) 514 that hosts the anchor cell and a second DU (DU2) 516 that hosts the NES cell. In some examples, the CU 512 and the DUs 514 and 516 may communicate via an F1 interface. In the second deployment, the anchor cell and the NES cell may be served by different DUs 514 and 516 of the same logical network node (for example, the same disaggregated network node). For example, the anchor cell and the NES cell may be served by different gNB-DUs of the same gNB.

Example 520 shows a third deployment. As shown in example 520, the third deployment includes a first network node 522 associated with the anchor cell and a second network node 524 associated with the NES cell. The first network node 522 may include a first CU (CU1), and the second network node 524 may include a second CU (CU2). For example, the first network node 522 may be a first logical (or disaggregated) network node, such as a first gNB (gNB1), including the first CU and one or more DUs, and the second network node 524 may be a second logical (or disaggregated) network node, including the second CU and one or more DUs. In the third deployment, the anchor cell and the NES cell may be served by different logical network nodes 522 and 524 (for example, different gNBs). The anchor cell may be served by the first network node 522 (for example, the first gNB), and the NES cell may served by the second network node 524 (for example, the second gNB). For example, a DU of the first network node 522 may host the anchor cell, and a DU of the second network node 524 may host the NES cell. In some examples, the first network node 522 and the second network node 524 may communicate via an Xn interface. For example, the first CU of the first network node 522 may communication with the second CU of the second network node 524 via the Xn interface. In some examples, the DU hosting the anchor cell may communicate with the first CU via an F1 interface, and the DU hosting the NES cell may communicate with the second CU via an F1 interface.

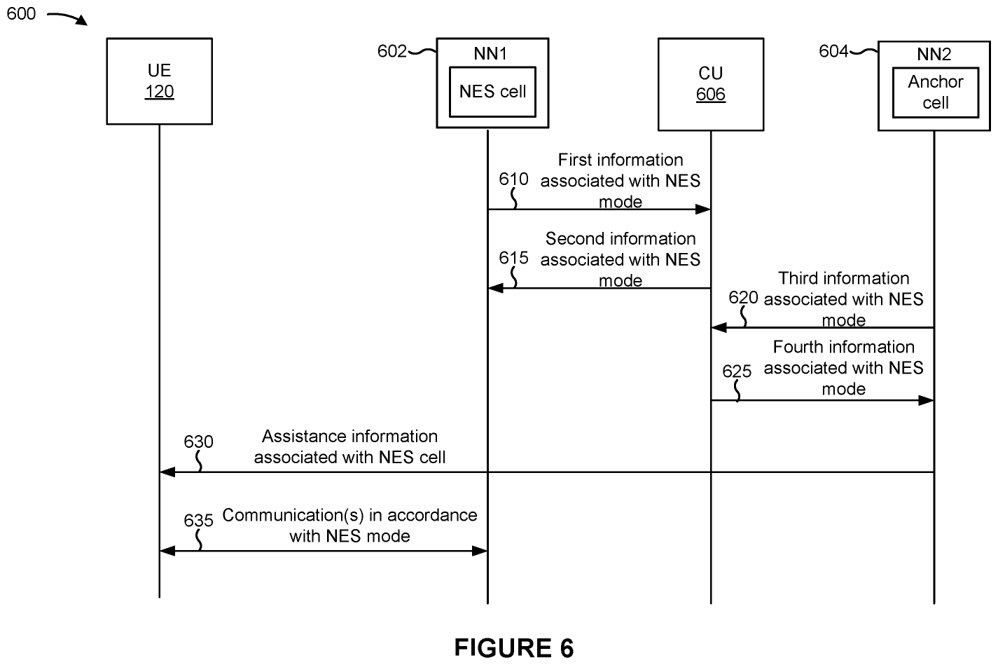

FIG. 6 is a diagram of an example 600 associated with backhaul signaling to support NES, in accordance with the present disclosure. As shown in FIG. 6, example 600 may include a first network node 602 (for example, network node 110, CU 310, DU 330, and/or RU 340), a second node 604 (for example, network node 110, CU 310, DU 330, and/or RU 340), a CU 606 (for example, CU 310), and a UE 120. The first network node 602 may be referred to as “NN1 602,” and the second network node 604 may be referred to as “NN2 604.” In some aspects, the NN1 602, the NN2 604, the CU 606, and the UE 120 may be part of a wireless communication network (for example, wireless communication network 100).

The NN1 602 may be a network node associated with an NES cell. In some aspects, the NN1 602 may be a DU that hosts (or serves) the NES cell. In some other aspects, the NN1 602 may be a logical network node (for example, including a CU and one or more DUs) that hosts (or serves) the NES cell (for example, on a DU of the NN1 602). For example, the NN1 602 may be a gNB or base station (for example, a 4G base station, a 5G base station, or a 6G base station, among other examples) associated with the NES cell (for example, a gNB or base station that hosts or serves the NES cell). The NN2 604 may be a network node associated with an anchor cell. In some aspects, the NN2 604 may be a DU that hosts (or serves) the anchor cell. In some other aspects, the NN2 604 may be a logical network node (for example, including a CU and one or more DUs) that hosts (or serves) the anchor cell (for example, on a DU of the NN2 604). For example, the NN2 604 may be a gNB or base station (for example, a 4G base station, a 5G base station, or a 6G base station, among other examples) associated with the anchor cell (for example, a gNB or base station that hosts or serves the NES cell). The CU 606 may be a CU associated with a network node that hosts or serves the NES cell (for example, the NN1 602), and/or a CU associated with a network node that hosts or serves the anchor cell (for example, the NN2 604).

In some aspects, the NN1 602, the NN2 604, and the CU 606 may be part of the same logical network node (for example, the same gNB). For example, the NN1 602 and the NN2 604 may be DUs of the same logical network node (for example, the same gNB). That is, the NES cell and the anchor cell may be served by DUs of the same logical network node (for example, the same gNB). In such an example, the NN1 602 and the NN2 604 may be different DUs (for example, the second deployment discussed in connection with FIG. 5), or the NN1 602 and the NN2 604 may be the same DU (for example, the first deployment discussed in connection with FIG. 5). In some other aspects, the NES cell and the anchor cell may be served by different logical network nodes (for example, different gNBs), such as in the third deployment discussed in connection with FIG. 5. In such examples, the CU 606 may be associated with the network node that hosts or serves the NES cell (for example, the NN1 602 and the CU 606 may both be part of the same logical network node), or the CU 606 may be associated with the network node that hosts or serves the anchor cell (for example, the NN2 604 and the CU 606 may both part of the same logical network node).

As shown in FIG. 6, in a first operation 610, the NN1 602 may transmit, via backhaul signaling, first information associated with an NES mode of the NES cell. The CU 606 may receive, via backhaul signaling, the first information transmitted by the NN1 602. As further shown in FIG. 6, in a second operation 615, the CU 606 may transmit, via backhaul signaling, second information associated with the NES mode of the NES cell. The NN1 602 may receive, via backhaul signaling, the second information transmitted by the CU 606. “Backhaul signaling” may refer to any communication between network entities (for example, CUs, DUs, and RUs) of a logical network node (for example, in a disaggregated network node architecture), any communication between network nodes (for example, between logical network nodes), and/or communication between a network node or network entity and a core network or device of a core network. In some aspects, the backhaul signaling for transmitting the first information and the second information between the NN1 602 and the CU 606 may include signaling via an F1 interface (for example, between a DU and a CU), signaling via an Xn interface (for example, between a first gNB and a second gNB), signaling via an X2 interface (for example between a 4G network node and a 5G network node), or signaling via an application program interface (API) (for example, and API exposed by a central entity, such as the CU 606). In some aspects, the NN1 602 may include the first information in served cell information of the NES cell (for example, in a served cell information element (IE)) or in neighbor cell information (for example, in a neighbor cell IE).

In some aspects, the NN1 602 may be a DU and the CU 606 may be a CU of a same logical network node as the NN1 602. In such examples, the first information may be transmitted, via backhaul signaling, from the NES cell (for example, the DU hosting the NES cell) to the CU 606, and the second information may be transmitted, via backhaul signaling, from the CU 606 to the NES cell (for example, the DU hosting the NES cell). In such examples, the first information and the second information may be transmitted via the F1 interface (or via an API exposed by a central entity, such as the CU 606). In some other aspects, the NN1 602 may be a first logical network node (for example, a first gNB) associated with the NES cell, and the NN1 602 may transmit the first information to, and receive the second information from, a second logical network node (for example, a second gNB) associated with the anchor cell. In such examples, the CU 606 may be a CU of the second logical network node (for example, the second gNB), and a CU of the NN1 602 may transmit the first information, and receive the second information from, the CU 606. In such examples, the first information and the second information may be transmitted via an Xn interface (or via an API). Alternatively, in an example in which the NES cell and the anchor cell are on different RATs (for example, the first logical network node (the NN1 602) is associated with a first RAT and the second logical network node is associated with a second RAT), the first information and the second information may be transmitted via a different base station interface, such as an X2 interface (for example, between a 4G network node and a 5G network node).

In some aspects, the first information described in connection with the first operation 610 and/or the second information described in connection with the second operation 615 may include information transmitted via multiple communications/messages. For example, the NN1 602 and the CU 606 may exchange the first information and the second information in multiple messages transmitted via the backhaul signaling. In some aspects, the NN1 602 may transmit the first information, or at least a portion of the first information, before the CU 606 transmits at least a portion of the second information. In such examples, the CU 606 may transmit at least a portion of the second information after (for example, in response to) receiving at least a portion of the first information. In some other aspects, the CU 606 may transmit the second information, or at least a portion of the second information, before the NN1 602 transmits at least a portion of the first information. In such examples, the NN1 602 may transmit at least a portion of the first information after (for example, in response to) receiving at least a portion of the second information.

In some aspects, the first information and the second information may include information associated with activating the NES cell to operate in the NES mode. For example, in some aspects, the first information may include, that a cell (for example, the NES cell) of the NN1 602 supports an NES mode (or multiple NES modes). In some examples, the NN1 602 may transmit (in the first information) capability information that indicates one or more one or more supported NES modes for the cell. For example, the capability information may indicate whether the cell (for example, the NES cell) supports an on-demand SIB1 mode, an SIB1-less mode, a hybrid on-demand SIB1 mode (where SIB1 is transmitted infrequently by the NES cell), and/or one or more other NES modes (such as an NES mode associated with reduced synchronization signal block (SSB) transmission on the NES cell).

In some aspects, the first information (transmitted from the NN1 602 to the CU 606) may include an indication of an active NES mode for the NES cell. The indication of the active NES mode for the NES cell may be an indication that the NES cell is operating in a particular NES mode. For example, the NN1 602 may determine to activate an NES mode on a cell (the NES cell) served by the NN1 602, and the NN1 602 may transmit the indication of the active NES mode for the NES cell to notify the CU 606 of the activation of the NES mode on the NES cell. In some examples, the indication of the active NES mode for the NES cell may indicate the NES cell and the active NES mode that the NES cell is operating in. For example, the indication of the active NES mode for the NES cell may indicate that the active NES mode is the on-demand SIB1 mode, the SIB1-less mode, the hybrid on-demand SIB 1 mode, or another NES mode. In some aspects, the second information (transmitted from the CU 606 to the NN1 602) may include an acknowledgement (for example, a mode acknowledgement (ACK)) of the active NES mode of the NES cell, or a rejection (for example, a mode negative acknowledgement (NACK)) of the active NES mode of the NES cell. For example, the CU 606, in response to receiving the indication of the active NES mode for the NES cell, may transmit a mode ACK to acknowledge (or approve) the NES cell operating in the indicated active NES mode (for example, the on-demand SIB1 mode, the SIB1-less mode, the hybrid on-demand SIB1 mode, or another NES mode) or a mode NACK to reject the NES cell operating in the indicated NES mode. The mode ACK or the mode NACK may be a one bit indication with a first value indicating the mode ACK or a second value indicating the mode NACK.

In some other aspects, the second information (transmitted from the CU 606 to the NN1 602) may include a request for the NES cell to operate in an NES mode. In such examples, the CU 606 may request that the NN1 602 operate a cell (the NES cell) in a particular NES mode (for example, request activation of the NES mode for the NES cell), rather than the NN1 602 indicating the active NES mode that is activated for the NES cell. For example, the request for the NES cell to operate in the NES mode may indicate the NES cell and the NES mode (for example, the on-demand SIB 1 mode, the SIB1-less mode, the hybrid on-demand SIB 1 mode, or another NES mode) to be activated for the NES cell. In some examples, the CU 606 may determine the NES mode indicated in the request based on or otherwise associated with the first information indicating the one or more supported NES modes for the NES cell. In some aspects, the first information (transmitted from the NN1 602 to the CU 606) may include an acknowledgment (for example, a mode ACK) of the request for the NES cell to operate in the NES mode, or a rejection (for example, a mode NACK) of the request for the NES cell to operate in the NES mode. For example, the NN1 602, in response to receiving the request for the NES cell to operate in the NES mode, may transmit a mode ACK to acknowledge (or approve) the request for the NES cell to operate in the NES mode (for example, the on-demand SIB 1 mode, the SIB1-less mode, the hybrid on-demand SIB1 mode, or another NES mode) or a mode NACK to reject the request for the NES cell to operate in the indicated NES mode (or to indicate failure of the NES cell to operate in the requested NES mode). In some examples, when the NN1 602 transmits the mode NACK, the NN1 602 may also transmit (for example, in the first information) a cause value that indicates a cause for the rejection of the request for the NES cell to operate in the indicated NES mode (or a cause for the failure of the NES cell to operate in the requested NES mode).

In some aspects, the first information (transmitted from the NN1 602 to the CU 606) may indicate an energy cost associated with the NES cell operating in the NES mode. In some examples, the energy cost may be a measurement or an estimation of an amount of energy to be consumed by the NES cell (for example, over a defined amount of time) when the NES cell is operating in the NES mode. In some examples, the energy cost may be indicated as a delta energy cost or energy saving associated with the NES cell operating in the NES mode (for example, as compared with the cell not operating in the NES mode). In some examples, the CU 606 may receive the first information indicating the energy cost associated with the NES cell operating in the NES mode, and the CU 606 (or another network device) may use the energy cost to determine whether to approve the active NES mode for the NES cell indicated by the NN1 602, to determine whether to request the NES cell to operate in the NES mode, and/or to determine one or more anchor cells to request or approve for the NES mode of the NES cell. For example, the CU 606 (or another network device) may determine the NES mode for the NES cell and/or which anchor cell(s) to be used for the NES mode of the NES to optimize a total network energy consumption based on or otherwise associated with the energy cost for the NES cell to operate in the NES mode.

In some aspects, the first information and/or the second information may include information relating to selection or activation of an anchor cell, associated with the NES cell, for the NES mode of the NES cell. In some aspects, the first information (transmitted from the NN1 602 to the CU 606) may indicate one or more anchor cells, associated with the NES cell, for the NES mode of the NES cell. For example, the first information may indicate a cell to be used as the anchor cell associated with the NES cell or a list of multiple cells to be used as anchor cells associated with the NES cell. In some examples, the first information may indicate a request anchor cell to be associated with the NES cell or a requested list of anchor cells to be associated with the NES cell. In some examples, the first information may indicate a candidate anchor cell to be associated with the NES cell or a list of candidate anchor cells to be associated with the NES cell. For example, the second information (transmitted from the CU 606 to the NN1 602) may indicate a set of candidate anchor cells. In such an example, the NN1 602 may receive the second information indicating the set of candidate anchor cells, and the NN1 602 may transmit the first information indicating a selected candidate anchor cell from the set of candidate anchor cells or a selected list of candidate anchor cells from the set of candidate anchor cells.

In some aspects, the second information (transmitted from the CU 606 to the NN1 602) may indicate a selected anchor cell associated with the NES cell for the NES mode or a selected list of anchor cells associated with the NES cell for the NES mode. In some examples, the selected anchor cell or list of anchor cells indicated in the second information may be selected by the CU 606 based on or otherwise associated with the requested anchor cell or requested list of anchor cells indicated in the first information. In some other examples, the selected anchor cell or list of anchor cells indicated in the second information may be selected by the CU 606 independent of receiving first information indicating the requested anchor cell or requested list of anchor cells.

In some aspects, the first information (transmitted from the NN1 602 to the CU 606) may include NES configuration information associated with the NES mode that is to be offloaded to the anchor cell (or anchor cells). That is, the NES configuration information included in the first information may be configuration information associated with the NES mode for the NES cell that is to be transmitted via the anchor cell (or via multiple anchor cells) to enable one or more UEs to access the NES cell while the NES cell is operating in the NES state. In some aspects, in an example in which the NES mode of the NES cell is the on-demand SIB1 mode (or the hybrid on-demand SIB1-mode), the NES configuration information may include a WUS configuration and a post-demand SIB 1 transmission configuration associated with the NES cell. The WUS configuration may include configuration information for a WUS signal to be transmitted by a UE (for example, the UE 120) to trigger the on-demand SIB1 transmission by the NES cell. For example, the WUS configuration may configure the WUS and WUS occasions for transmission of the WUS. The post-demand SIB 1 transmission configuration associated with the NES cell may indicate a transmission configuration for transmission of the SIB1 by the NES cell once the SIB1 transmission is demanded (for example, in response to the NES cell receiving the WUS). For example, the post-demand SIB1 transmission configuration associated with the NES cell may indicate a number of broadcast periods in which the SIB1 is to be transmitted by the NES cell, which beam directions are to be used for transmitting the SIB1 by the NES cell, and/or a period length associated with transmitting the SIB1 by the NES cell, among other examples.

In some other aspects, the NES configuration information may include system information associated with the NES cell. In some aspect, in an example in which the NES mode of the NES cell is the SIB1-less mode, the NES configuration information included in the first information may include the SIB1 associated with the NES cell, part of the SIB1 associated with the NES cell (for example, a portion of the system information included in the SIB1 associated with the NES cell), and/or other system information associated with the NES cell. In some other aspects, in an example in which the NES mode of the NES cell is an NES mode associated with reduced SSB transmission on the NES cell, the NES configuration information may include configuration information similar to the NES configuration information discussed above in connection with the on-demand SIB1 mode.

In some aspects, the second information (transmitted from the CU 606 to the NN1 602) may indicate NES configuration information associated with the NES mode. For example, the CU 606 may determine a configuration for the NES cell to operate in the NES mode, and the CU 606 may transmit the NES configuration information associated with the NES mode to the NN1 602 to indicate the configuration for the NES cell to operate in the NES mode. In some aspects, in an example in which the NES mode is the on-demand SIB1 mode (or the hybrid on-demand SIB1 mode), the NES configuration information indicated in the second information may indicate the WUS configuration (for example, including a configuration of WUS occasions) for triggering the on-demand SIB1 transmission by the NES cell and/or the post-demand SIB 1 transmission configuration associated with the NES cell (for example, the transmission configuration for transmitting the SIB1 once the SIB1 transmission is demanded by a UE). Additionally or alternatively, in an example in which the NES mode is the hybrid on-demand SIB 1 mode, the NES configuration information indicated in the second information may indicate a selected SIB1 broadcast periodicity for the NES cell while operating in the hybrid on-demand SIB1 mode (for example, prior to the SIB1 transmission being demanded by a UE).

In some aspects, the first information and/or the second information may include cell-specific information associated with the NES mode of the NES cell. For example, the first information and/or the second information may activate the NES mode for the NES cell, and the NES mode may apply to all SIB 1 transmissions on the NES cell. In such examples, the anchor cell (or anchor cells) and the NES configuration information may also be applied at a cell level for the NES cell.

In some other aspects, the first information and/or the second information may include beam-specific information. For example, the first information and/or the second information may include beam-specific associated with the NES mode of the NES cell. In some aspects, the first information and/or the second information may include beam-specific information associated with activating one or more beam-specific NES modes for the NES cell. In some examples, the first information may include indications of one or more beam-specific NES modes supported by the NES cell, and/or indications of one or more active beam-specific NES modes of the NES cell. In some examples, the second information may include a request for the NES cell to operate using one or more beam-specific NES modes. In such examples, the beam-specific information may enable activation of beam-specific NES modes that apply different NES modes for SIB 1 transmissions on different beams. For example, the NES cell may apply the SIB1-less mode and skip SIB1 transmission on a first subset of beams, the NES cell may apply the on-demand SIB1 mode for a second subset of beams, and/or the NES cell may apply the hybrid on-demand SIB1 mode for a third subset of beams.

In some aspects, the first information and/or the second information may include beam-specific information indicating one or more anchor cells. For example, the first information and/or the second information may include beam-specific information that indicates different candidate anchor cells for different beams. In some aspects, the first information and/or the second information may include beam-specific NES configuration information. In some examples, the NES configuration information associated with the on-demand NES mode (or the hybrid on-demand NES mode) may include different post-demand SIB1 transmission configurations (for example, having different period lengths and/or different numbers of broadcast periods) for SIB1 transmissions on different beams.

In some aspects, the NN1 602 may update the first information (for example, by transmitting updated first information). For example, the NN1 602 may update the first information in connection with a change in the first information, such as a change in an active NES mode, a change in a supported NES mode, a change in a requested or selected anchor cell or list of anchor cells, and/or a change in NES configuration information, among other examples. In some aspects, the CU 606 may update the second information (for example, by transmitting updated second information). For example, the CU 606 may update the second information in connection with a change in the second information, such as a change in a requested NES mode for the NES cell, a change in a set of candidate anchor cells or selected anchor cell or list of anchor cells, and/or a change in the configuration for the NES cell to operate in the NES mode, among other examples.

As further shown in FIG. 6, in a third operation 620, the NN2 604 may transmit third information associated with the NES mode of the NES cell via backhaul signaling. The CU 606 may receive the third information transmitted by the NN2 604 via backhaul signaling. In a fourth operation 625, the CU 606 may transmit fourth information associated with the NES mode of the NES cell via backhaul signaling. The NN2 604 may receive the fourth information transmitted by the CU 606 via backhaul signaling. In some aspects, the backhaul signaling for transmitting the first information and the second information between the NN1 602 and the CU 606 may include signaling via an F1 interface (for example, between a DU and a CU), signaling via an Xn interface (for example, between a first gNB and a second gNB), signaling via an X2 interface (for example between a 4G network node and a 5G network node), or signaling via an API (for example, and API exposed by a central entity, such as the CU 606). In some aspects, the NN2 604 may include the third information in served cell information of the anchor cell (for example, in a served cell IE) or in neighbor cell information (for example, in a neighbor cell IE).

In some aspects, the NN2 604 may be a DU and the CU 606 may be a CU of a same logical network node as the NN2 604. In such examples, the third information may be transmitted, via backhaul signaling, from the anchor cell (for example, the DU hosting the anchor cell) to the CU 606, and the fourth information may be transmitted, via backhaul signaling, from the CU 606 to the anchor cell (for example, the DU hosting the NES cell). In such examples, the third information and the fourth information may be transmitted via the F1 interface (or via an API exposed by a central entity, such as the CU 606). In some other aspects, the NN2 604 may be a second logical network node (for example, a second gNB) associated with the anchor cell, and the NN2 604 may transmit the first information to, and receive the second information from, a first logical network node (for example, a first gNB) associated with the NES cell. In such examples, the CU 606 may be a CU of the first logical network node (for example, the first gNB), and a CU of the NN2 604 may transmit the third information, and receive the fourth information from, the CU 606. In such examples, the third information and the fourth information may be transmitted via an Xn interface (or via an API). Alternatively, in an example in which the NES cell and the anchor cell are on different RATs (for example, the first logical network node is associated with a first RAT and the second logical network node (for example, the NN2 604) is associated with a second RAT), the third information and the fourth information may be transmitted via a different base station interface, such as an X2 interface (for example, between a 4G network node and a 5G network node).

In some aspects, the third information described in connection with the third operation 620 and/or the fourth information described in connection with the fourth operation 625 may include information transmitted via multiple communications/messages. For example, the NN2 604 and the CU 606 may exchange the third information and the fourth information in multiple messages transmitted via the backhaul signaling. In some aspects, the NN2 604 may transmit the third information, or at least a portion of the first information, before the CU 606 transmits at least a portion of the fourth information. In such examples, the CU 606 may transmit at least a portion of the fourth information after (for example, in response to) receiving at least a portion of the third information. In some other aspects, the CU 606 may transmit the fourth information, or at least a portion of the fourth information, before the NN2 604 transmits at least a portion of the third information. In such examples, the NN2 604 may transmit at least a portion of the third information after (for example, in response to) receiving at least a portion of the fourth information.

In some aspects, the third information and the fourth information may include information associated with activating the anchor cell to operate in an anchor mode for the NES cell operating in the NES state. For example, in some aspects, the third information may include, that a cell (for example, the anchor cell) of the NN2 604 supports an anchor mode. In some examples, the NN2 604 may transmit (in the third information) capability information that indicates whether the cell (for example, the anchor cell) supports operating as an anchor cell for an NES cell operating in an NES mode. For example, the capability information may indicate whether the cell (for example, the anchor cell) supports an anchor mode for one or more NES modes of an NES cell (for example, for the on-demand SIB1 mode, the SIB1-less mode, the hybrid on-demand SIB1 mode, and/or one or more other NES modes).

In some aspects, the third information (transmitted from the NN2 604 to the CU 606) may include an indication of an active anchor mode for the anchor cell. The indication of the active anchor mode for the anchor cell may be an indication that the anchor cell is operating (or requesting to operate) as an anchor cell for an NES cell (for example, the NES cell hosted on the NN1 602). For example, the NN2 604 may determine to activate the anchor mode on a cell (the anchor cell) served by the NN2 604, and the NN2 604 may transmit the indication of the active anchor mode for the anchor cell to notify the CU 606 of the activation of the anchor mode for the anchor cell. In some examples, the NN2 604 may receive (for example, in the fourth information) an indication of the NES cell and the NES mode of the NES cell, and the NN2 604 may determine to activate the anchor mode for the anchor cell for the NES cell operating in the NES mode. In such examples, the indication of the active anchor mode for the anchor cell may indicate the NES cell associated with the anchor cell and the NES mode of the NES cell. In some aspects, the fourth information (transmitted from the CU 606 to the NN2 604) may include an acknowledgement (for example, a mode ACK) that the anchor cell is operating in the anchor mode for the NES cell, or a rejection (for example, a mode NACK) of the anchor cell operating in the anchor mode for the NES cell. For example, the CU 606, in response to receiving the indication of the active anchor mode for the anchor cell, may transmit a mode ACK to acknowledge (or approve) the anchor cell operating in the anchor mode for the NES cell or a mode NACK to reject the anchor cell operating in the anchor mode for the NES cell. The mode ACK or the mode NACK may be a one bit indication with a first value indicating the mode ACK or a second value indicating the mode NACK.

In some other aspects, the fourth information (transmitted from the CU 606 to the NN2 604) may include a request for the anchor cell to operate in an anchor mode for the NES cell. In such examples, the CU 606 may request that the NN2 604 operate a cell (the anchor cell) in an anchor mode, rather than the NN2 604 indicating that the anchor cell is operating in the anchor mode. For example, the request for the anchor cell to operate in the anchor mode may indicate the NES cell for which the anchor cell is to operate in the anchor mode and the NES mode of the NES cell. In some examples, the CU 606 may request that the anchor cell operate in the anchor mode based on or otherwise associated with the third information indicating that the anchor cell supports the anchor mode. In some aspects, the third information (transmitted from the NN2 604 to the CU 606) may include an acknowledgment (for example, a mode ACK) of the request for the anchor cell to operate in the anchor mode for the NES cell, or a rejection (for example, a mode NACK) of the request for the anchor cell to operate in the anchor mode for the NES cell. For example, the NN2 604, in response to receiving the request for the anchor cell to operate in the anchor mode, may transmit a mode ACK to acknowledge (or approve) the request for the anchor cell to operate in the anchor mode or a mode NACK to reject the request for the anchor cell to operate in the indicated anchor mode (or to indicate failure of the anchor cell to operate in the anchor mode for the NES cell). In some examples, when the NN2 604 transmits the mode NACK, the NN2 604 may also transmit (for example, in the third information) a cause value that indicates a cause for the rejection of the request for the anchor cell to operate in the anchor mode (or a cause for the failure of the anchor cell to operate in the anchor mode for the NES cell).

In some aspects, the third information (transmitted from the NN2 604 to the CU 606) may indicate an energy cost associated with the anchor cell operating in the anchor mode for the NES cell. In some examples, the energy cost may be a measurement or an estimation of an amount of energy to be consumed by the anchor cell (for example, over a defined amount of time) when the anchor cell is operating in the anchor mode for the NES cell operating in the NES mode. In some examples, the energy cost may be indicated as a delta energy cost or energy increase associated with the anchor cell operating in the anchor mode (for example, as compared with the cell not operating in the anchor mode). In some examples, the CU 606 may receive the third information indicating the energy cost associated with the anchor cell operating in the anchor mode, and the CU 606 (or another network device) may use the energy cost to determine whether to approve the anchor cell operating in the anchor mode for the NES cell, to determine whether to request the anchor cell to operate in the anchor mode for the NES cell, and/or to determine whether to request or approve the NES cell operating in the NES mode. For example, the CU 606 (or another network device) may determine the NES mode for the NES cell and/or the anchor cell to be used for the NES mode of the NES to optimize a total network energy consumption based on or otherwise associated with the energy cost indicated in the first information for the NES cell to operate in the NES mode and the energy cost indicated in the third information for the anchor cell to operate in the anchor mode.

In some aspects, the third information and/or the fourth information may include information relating to the NES cell and/or the NES mode of the NES cell. In some aspects, the third information (transmitted from the NN2 604 to the CU 606) may indicate one or more NES cells associated with the anchor cell. For example, the third information may indicate a NES cell associated with the anchor cell or a list of multiple NES cells associated with the anchor cell. In some examples, the third information may indicate a request NES cell to be associated with the anchor cell or a requested list of NES cells to be associated with the anchor cell. In some examples, the third information may indicate a candidate NES cell to be associated with the anchor cell or a list of candidate NES cells to be associated with the anchor cell. For example, the fourth information (transmitted from the CU 606 to the NN2 604) may indicate a set of candidate NES cells. In such an example, the NN2 604 may receive the fourth information indicating the set of candidate NES cells, and the NN2 604 may transmit the third information indicating a selected candidate NES cell from the set of candidate NES cells or a selected list of candidate NES cells from the set of candidate NES cells.

In some aspects, the third information (transmitted from the NN2 604 to the CU 606) may indicate a type of NES-cell-related information to be offloaded to the anchor cell. For example, the third information may indicate one or more preferred, supported, or requested types of NES-cell-related information to be transmitted by the anchor cell (on behalf of the NES cell) while the anchor cell is operating in the anchor mode for the NES cell. The one or more preferred, supported, or requested types of NES-cell-related information may correspond to one or more NES modes. For example, the one or more preferred, supported, or requested types of NES-cell-related information indicated in the third information may include WUS configuration, SIB1, a portion of SIB1, and/or other system information, among other examples.

In some aspects, the fourth information (transmitted from the CU 606 to the NN2 604) may indicate a selected NES cell associated with the anchor cell or a selected list of NES cells associated with the anchor cell. In some examples, the selected NES cell or list of NES cells indicated in the fourth information may be selected by the CU 606 based on or otherwise associated with the requested NES cell or requested list of NES cells indicated in the third information and/or the one or more preferred, supported, or requested types of NES-cell-related information indicated in the third information. In some other examples, the selected NES cell or list of NES cells indicated in the fourth information may be selected by the CU 606 independent of receiving third information indicating the requested NES cell or requested list of NES cells and/or third information indicating the one or more preferred, supported, or requested types of NES-cell-related information. In some examples, the fourth information may indicate the NES mode of the selected NES cell or the NES modes of the NES cells in the selected list of NES cells.

In some aspects, the fourth information (transmitted from the CU 606 to the NN2 604) may include NES configuration information, associated with the NES mode of the NES cell, that is to be offloaded to the anchor cell. That is, the NES configuration information included in the fourth information may be configuration information associated with the NES mode for the NES cell that is to be transmitted via the anchor cell to enable one or more UEs to access the NES cell while the NES cell is operating in the NES state. In some examples, the CU 606 may receive the NES configuration information associated with the NES mode of the NES cell from the NN1 602 (for example, in the first information), and the CU 606 may forward the NES configuration information to the NN2 604 in the fourth information.

In some aspects, in an example in which the NES mode of the NES cell is the on-demand SIB1 mode (or the hybrid on-demand SIB1-mode), the NES configuration information may include a WUS configuration and a post-demand SIB 1 transmission configuration associated with the NES cell. The WUS configuration may include configuration information for a WUS signal to be transmitted by a UE (for example, the UE 120) to trigger the on-demand SIB 1 transmission by the NES cell. For example, the WUS configuration may configure the WUS and WUS occasions for transmission of the WUS. The post-demand SIB1 transmission configuration associated with the NES cell may indicate a transmission configuration for transmission of the SIB1 by the NES cell once the SIB1 transmission is demanded (for example, in response to the NES cell receiving the WUS). For example, the post-demand SIB1 transmission configuration associated with the NES cell may indicate a number of broadcast periods in which the SIB1 is to be transmitted by the NES cell, which beam directions are to be used for transmitting the SIB1 by the NES cell, and/or a period length associated with transmitting the SIB1 by the NES cell, among other examples.

In some other aspects, the NES configuration information may include system information associated with the NES cell. In some aspect, in an example in which the NES mode of the NES cell is the SIB1-less mode, the NES configuration information included in the fourth information may include the SIB1 associated with the NES cell, part of the SIB1 associated with the NES cell (for example, a portion of the system information included in the SIB 1 associated with the NES cell), and/or other system information associated with the NES cell. In some other aspects, in an example in which the NES mode of the NES cell is an NES mode associated with reduced SSB transmission on the NES cell, the NES configuration information may include configuration information similar to the NES configuration information discussed above in connection with the on-demand SIB1 mode.

In some aspects, the third information (transmitted from the NN2 604 to the CU 606) may include an anchor configuration information. The anchor configuration information may be a transmission configuration for transmission of the NES configuration information associated the NES cell by the anchor cell while this anchor cell is performing the anchor functionality. In some examples, the anchor configuration may indicate a mode of delivery (for example, broadcast, on-demand broadcast, or on-demand unicast) of the NES configuration information associated with the NES cell to a UE (for example, the UE 120), one or more beams on which to transmit the NES configuration information, and/or a broadcast period or a range of broadcast periods for transmitting the NES configuration information, among other examples. In some aspects, the third information may indicate the anchor configuration information to be used by the anchor cell for transmitting the NES configuration information associated with the NES cell. In some other aspects, the third information may indicate supported (or requested) anchor configuration information for the anchor cell. For example, the supported anchor configuration information may indicate one or more supported transmission configurations for transmitting the NES configuration information associated with the NES cell. In some examples, the supported anchor configuration information may indicate supported parameters for transmission of the NES configuration information, such as a range of supported broadcast periods, a set or range of supported beams, and/or one or more supported modes of delivery, among other examples.

In some aspects, the fourth information (transmitted from the CU 606 to the NN2 604) may include the anchor configuration information for the anchor cell. For example, the CU 606 may determine a configuration for the anchor cell while performing anchor functionality (for example, while operating in the anchor mode) for the NES cell, and the CU 606 may transmit the anchor configuration information to the NN2 604 to indicate the configuration for the anchor cell functionality performed by the anchor cell. In some aspects, the anchor configuration information may indicate a transmission configuration for transmission of the NES configuration information associated with the NES cell by the anchor cell. For example, the anchor configuration information may indicate a mode of delivery (for example, broadcast, on-demand broadcast, or on-demand unicast) of the NES configuration information to a UE (for example, the UE 120), one or more beams on which to transmit the NES configuration information, and/or a broadcast period or allowed periodicity range for transmitting the NES configuration information, among other examples.

In some aspects, the third information and/or the fourth information may include cell-specific information. In some other aspects, the third information and/or the fourth information may include beam-specific information. For example, the third information and/or the fourth information may include beam-specific associated with the anchor cell. In some aspects, the first information and/or the second information may include beam-specific anchor configuration information. In some examples, the beam-specific anchor configuration information may configure the anchor cell to transmit NES configuration information associated with an NES cell on a subset of beams. In some examples, the beam-specific anchor configuration information the anchor cell to transmit NES configuration information associated with different NES cells on different beams. In some examples, the beam-specific anchor configuration may include a first transmission configuration (for example, with a first period length and a first delivery mode) for transmission of the NES configuration information on a first beam, and a second transmission configuration (for example, with a second period length and a second delivery mode) for transmission of the NES configuration information on a second beam.

In some aspects, beam-specific configuration information may be used to configure a cell (for example, the anchor cell) to transmit system information (for example, the SIB1 and/or other system information) associated with the cell using different modes of delivery on different beams. For example, a CU (for example, the CU 606) may transmit such beam-specific configuration information to a network node associated with the cell (for example, the NN2 604) to configure the cell to transmit the system information using different modes of delivery on different beams.

In some aspects, the NN2 604 may update the third information (for example, by transmitting updated third information). For example, the NN2 604 may update the third information in connection with a change in the third information. In some aspects, the CU 606 may update the fourth information (for example, by transmitting updated fourth information). For example, the CU 606 may update the fourth information in connection with a change in the fourth information.

As further shown in FIG. 6, in a fifth operation 630, the NN2 604 may transmit, via the anchor cell, assistance information associated with the NES cell. The UE 120 may receive the assistance information via the anchor cell. The assistance information may include information to enable the UE 120 to access the NES cell while the NES cell is operating in the NES mode.

In some aspects, the assistance information may include the NES configuration information associated with the NES mode of the NES cell. In some aspects, in an example in which the NES mode of the NES cell is the on-demand SIB1 mode (or the hybrid on-demand SIB 1 mode), the assistance information may include the WUS configuration and the post-demand SIB 1 transmission configuration associated with the NES cell. In some aspects, in an example in which the NES mode of the NES cell is the SIB1-less mode, the assistance information may include system information associated with the NES cell, such as an SIB1 associated with the NES cell, part of the SIB1 associated with the NES cell, and/or other system information associated with the NES cell. In some aspects, the NN2 604 may transmit the assistance information (for example, including the NES configuration information) via the anchor cell in accordance with the anchor configuration indicated in the fourth information and/or the third information.

As further shown in FIG. 6, in a sixth operation 635, NN1 602 and the UE 120 may communicate via the NES cell in accordance with the NES mode of the NES cell. For example, while the NES cell is operating in the NES mode, the UE 120 may communication with the NES cell (for example, with the NN1 602) to access the NES cell based on or otherwise associated with the assistance information received by the UE 120 via the anchor cell.

In an example in which the NES mode of the NES cell is the on-demand SIB1 mode, the UE 120 (for example, while in an RRC idle or RRC inactive state) may transmit a WUS toward the NN2 604 in accordance with the WUS configuration indicated in the assistance information. The NES cell may receive the WUS, and the NES cell may transmit the SIB1 associated with the NES cell in accordance with the post-demand SIB1 transmission configuration associated with the NES cell. The UE 120 may receive the SIB1 transmitted by the NES cell in accordance with the post-demand SIB 1 transmission configuration associated with the NES cell indicated in the assistance information. The UE 120 may initiate an initial access procedure with the NES cell based on or otherwise associated with the system information included in the SIB1, and UE 120 may communicate with the NES cell in the initial access procedure to establish a connection with the NES cell.

In an example in which the NES mode of the NES cell is the SIB1-less mode, the SIB 1 associated with the NES cell may be included in the assistance information received by the UE 120 via the anchor cell. The UE 120 may initiate an initial access procedure with the NES cell based on or otherwise associated with the system information included in the SIB1, and UE 120 may communicate with the NES cell in the initial access procedure to establish a connection with the NES cell.

FIG. 7 is a flowchart illustrating an example process 700 performed, for example, at a network node or an apparatus of a network node associated with an NES cell in accordance with the present disclosure. Example process 700 is an example where the apparatus or the network node (for example, network node 110, CU 310, DU 330, RU 340, or NN1 602) performs operations associated with backhaul signaling to support NES.

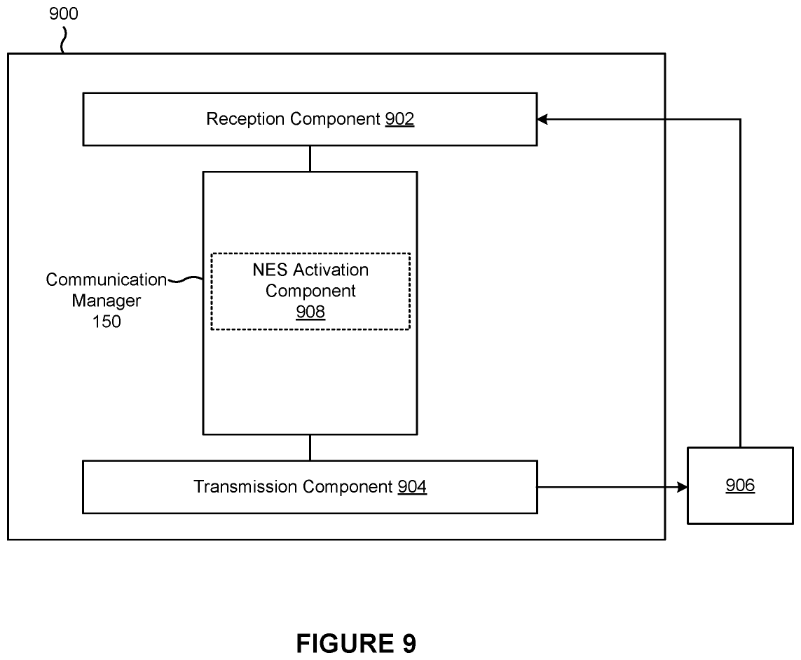

As shown in FIG. 7, in some aspects, process 700 may include transmitting, via backhaul signaling, information associated with an NES mode of the NES cell (block 710). For example, the network node (such as by using communication manager 150 or transmission component 904, depicted in FIG. 9) may transmit, via backhaul signaling, information associated with an NES mode of the NES cell, as described above.

As further shown in FIG. 7, in some aspects, process 700 may include communicating with a UE via the NES cell in accordance with the NES mode (block 720). For example, the network node (such as by using communication manager 150, reception component 902, or transmission component 904, depicted in FIG. 9) may communicate with a UE via the NES cell in accordance with the NES mode, as described above.

Process 700 may include additional aspects, such as any single aspect or any combination of aspects described below or in connection with one or more other processes described elsewhere herein.

In a first additional aspect, the information includes an indication that the NES mode is a supported NES mode for the NES cell.

In a second additional aspect, alone or in combination with the first aspect, the information includes an indication that the NES mode is an active NES mode of the NES cell.

In a third additional aspect, alone or in combination with one or more of the first and second aspects, process 700 includes receiving, via backhaul signaling, an acknowledgement of the active NES mode of the NES cell or a rejection of the active NES mode of the NES cell.

In a fourth additional aspect, alone or in combination with one or more of the first through third aspects, process 700 includes receiving, via backhaul signaling, a request for the NES cell to operate in the NES mode, wherein the information includes an acknowledgment of the request for the NES cell to operate in the NES mode or a rejection of the request for the NES cell to operate in the NES mode.

In a fifth additional aspect, alone or in combination with one or more of the first through fourth aspects, the information indicates an energy cost associated with the NES cell operating in the NES mode.

In a sixth additional aspect, alone or in combination with one or more of the first through fifth aspects, the information indicates one or more anchor cells, associated with the NES cell, for the NES mode.

In a seventh additional aspect, alone or in combination with one or more of the first through sixth aspects, the information includes NES configuration information, associated with the NES mode, to be transmitted via an anchor cell.

In an eighth additional aspect, alone or in combination with one or more of the first through seventh aspects, the NES mode is an on-demand SIB1 mode, and the NES configuration information includes a WUS configuration, and a post-demand SIB 1 transmission configuration associated with the NES cell.

In a ninth additional aspect, alone or in combination with one or more of the first through eighth aspects, communicating with the UE via the NES cell in accordance with the NES mode includes receiving a WUS in accordance with the WUS configuration, and transmitting, in connection with receiving the WUS, an SIB1 via the NES cell in accordance with the post-demand SIB 1 transmission configuration.

In a tenth additional aspect, alone or in combination with one or more of the first through ninth aspects, the NES configuration information includes system information associated with the NES cell.

In an eleventh additional aspect, alone or in combination with one or more of the first through tenth aspects, process 700 includes receiving, via backhaul signaling, NES configuration information associated with the NES mode.

In a twelfth additional aspect, alone or in combination with one or more of the first through eleventh aspects, the NES configuration information indicates at least one of an SIB1 broadcast periodicity associated with a hybrid on-demand SIB1 NES mode, or a post-demand SIB 1 transmission configuration associated with an on-demand SIB1 NES mode or the hybrid on-demand SIB1 NES mode.

In a thirteenth additional aspect, alone or in combination with one or more of the first through twelfth aspects, the information includes beam-specific information associated with the NES mode.

In a fourteenth additional aspect, alone or in combination with one or more of the first through thirteenth aspects, the network node associated with the NES cell is a DU, and transmitting the information associated with the NES mode of the NES cell includes transmitting the information associated with the NES mode of the NES cell to a CU.

In a fifteenth additional aspect, alone or in combination with one or more of the first through fourteenth aspects, transmitting the information associated with the NES mode of the NES cell includes transmitting the information associated with the NES mode of the NES cell to another network node associated with an anchor cell.

In a sixteenth additional aspect, alone or in combination with one or more of the first through fifteenth aspects, the backhaul signaling includes signaling via an F1 interface, an Xn interface, an X2 interface, or an API.

Although FIG. 7 shows example blocks of process 700, in some aspects, process 700 may include additional blocks, fewer blocks, different blocks, or differently arranged blocks than those depicted in FIG. 7. Additionally or alternatively, two or more of the blocks of process 700 may be performed in parallel.

FIG. 8 is a flowchart illustrating an example process 800 performed, for example, at a network node or an apparatus of a network node associated with an anchor cell in accordance with the present disclosure. Example process 800 is an example where the apparatus or the network node (for example, network node 110, CU 310, DU 330, RU 340, or NN2 604) performs operations associated with backhaul signaling to support NES.

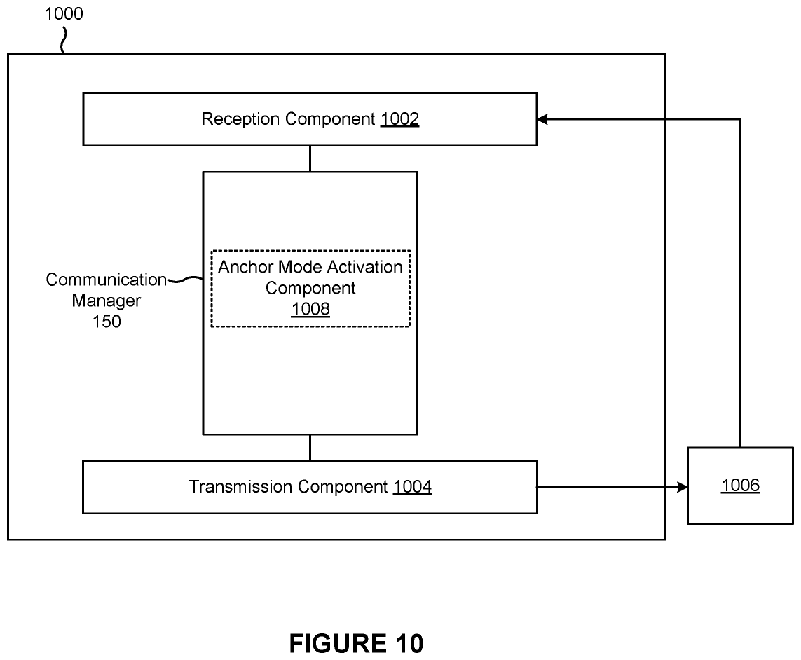

As shown in FIG. 8, in some aspects, process 800 may include receiving, via backhaul signaling, information associated with an NES mode of an NES cell (block 810). For example, the network node (such as by using communication manager 150 or reception component 1002, depicted in FIG. 10) may receive, via backhaul signaling, information associated with an NES mode of an NES cell, as described above.

As further shown in FIG. 8, in some aspects, process 800 may include transmitting, via the anchor cell, assistance information to enable a UE to access the NES cell in accordance with the NES mode (block 820). For example, the network node (such as by using communication manager 150 or transmission component 1004, depicted in FIG. 10) may transmit, via the anchor cell, assistance information to enable a UE to access the NES cell in accordance with the NES mode, as described above.

Process 800 may include additional aspects, such as any single aspect or any combination of aspects described below or in connection with one or more other processes described elsewhere herein.

In a first additional aspect, process 800 includes transmitting, via backhaul signaling, an indication that the anchor cell supports operating in an anchor mode for the NES cell.

In a second additional aspect, alone or in combination with the first aspect, the information includes a request for the anchor cell to operate in an anchor mode for the NES cell.

In a third additional aspect, alone or in combination with one or more of the first and second aspects, process 800 includes transmitting, via backhaul signaling, an acknowledgment of the request for the anchor cell to operate in the anchor mode for the NES cell or a rejection of the request for the anchor cell to operate in the anchor mode for the NES cell.

In a fourth additional aspect, alone or in combination with one or more of the first through third aspects, process 800 includes transmitting, via backhaul signaling, an indication that the anchor cell is operating in an anchor mode for the NES cell, wherein the information includes an acknowledgement of the anchor cell operating in the anchor mode for the NES cell or a rejection of the anchor cell operating in the anchor mode for the NES cell.

In a fifth additional aspect, alone or in combination with one or more of the first through fourth aspects, process 800 includes transmitting, via backhaul signaling, an indication of an energy cost associated with the anchor cell operating in an anchor mode for the NES cell.

In a sixth additional aspect, alone or in combination with one or more of the first through fifth aspects, the information indicates one or more NES cells, including the NES cell, associated with the anchor cell.

In a seventh additional aspect, alone or in combination with one or more of the first through sixth aspects, the information includes NES configuration information, associated with the NES mode, for the NES cell, and transmitting the assistance information includes transmitting the NES configuration information via the anchor cell.

In an eighth additional aspect, alone or in combination with one or more of the first through seventh aspects, the NES mode is an on-demand SIB1 mode, and the NES configuration information includes a WUS configuration, and a post-demand SIB 1 transmission configuration associated with the NES cell.

In a ninth additional aspect, alone or in combination with one or more of the first through eighth aspects, the NES configuration information includes system information associated with the NES cell.

In a tenth additional aspect, alone or in combination with one or more of the first through ninth aspects, the information includes transmission configuration information associated with transmission of the NES configuration information via the anchor cell.

In an eleventh additional aspect, alone or in combination with one or more of the first through tenth aspects, process 800 includes transmitting, via backhaul signaling, NES information indicating at least one of one or more NES cells, including the NES cell, associated with the anchor cell, or a type of NES configuration information for which transmission is supported by the anchor cell.

In a twelfth additional aspect, alone or in combination with one or more of the first through eleventh aspects, the information includes beam-specific information associated with the NES mode.

In a thirteenth additional aspect, alone or in combination with one or more of the first through twelfth aspects, the network node associated with the anchor cell is a DU, and receiving the information associated with the NES mode of the NES cell includes receiving the information associated with the NES mode of the NES cell from a CU.

In a fourteenth additional aspect, alone or in combination with one or more of the first through thirteenth aspects, receiving the information associated with the NES mode of the NES cell includes receiving the information associated with the NES mode of the NES cell from another network node associated with the NES cell.

In a fifteenth additional aspect, alone or in combination with one or more of the first through fourteenth aspects, the backhaul signaling includes signaling via an F1 interface, an Xn interface, an X2 interface, or an API.

Although FIG. 8 shows example blocks of process 800, in some aspects, process 800 may include additional blocks, fewer blocks, different blocks, or differently arranged blocks than those depicted in FIG. 8. Additionally or alternatively, two or more of the blocks of process 800 may be performed in parallel.

FIG. 9 is a diagram of an example apparatus 900 for wireless communication that supports backhaul signaling to support NES in accordance with the present disclosure. The apparatus 900 may be a network node associated with an NES cell, or a network node associated with an NES cell may include the apparatus 900. In some aspects, the apparatus 900 includes a reception component 902, a transmission component 904, and a communication manager 150, which may be in communication with one another (for example, via one or more buses). As shown, the apparatus 900 may communicate with another apparatus 906 (such as a UE, a network node, or another wireless communication device) using the reception component 902 and the transmission component 904.

In some aspects, the apparatus 900 may be configured to and/or operable to perform one or more operations described herein in connection with FIGS. 4-6. Additionally or alternatively, the apparatus 900 may be configured to and/or operable to perform one or more processes described herein, such as process 700 of FIG. 7. In some aspects, the apparatus 900 may include one or more components of the network node described above in connection with FIG. 2.

The reception component 902 may receive communications, such as reference signals, control information, and/or data communications, from the apparatus 906. The reception component 902 may provide received communications to one or more other components of the apparatus 900, such as the communication manager 150. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 902 may include one or more antennas, one or more modems, one or more demodulators, one or more MIMO detectors, one or more receive processors, one or more controllers/processors, and/or one or more memories of the network node described above in connection with FIG. 2.

The transmission component 904 may transmit communications, such as reference signals, control information, and/or data communications, to the apparatus 906. In some aspects, the communication manager 150 may generate communications and may transmit the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, one or more modems, one or more modulators, one or more transmit MIMO processors, one or more transmit processors, one or more controllers/processors, and/or one or more memories of the network node described above in connection with FIG. 2. In some aspects, the transmission component 904 may be co-located with the reception component 902 in one or more transceivers.

The communication manager 150 may transmit or may cause the transmission component 904 to transmit, via backhaul signaling, information associated with an NES mode of the NES cell. The communication manager 150 may communicate with a UE via the NES cell in accordance with the NES mode. In some aspects, the communication manager 150 may perform one or more operations described elsewhere herein as being performed by one or more components of the communication manager 150.

The communication manager 150 may include one or more controllers/processors, one or more memories, one or more schedulers, and/or one or more communication units of the network node described above in connection with FIG. 2. In some aspects, the communication manager 150 includes a set of components, such as an NES mode activation component 908 Alternatively, the set of components may be separate and distinct from the communication manager 150. In some aspects, one or more components of the set of components may include or may be implemented within one or more controllers/processors, one or more memories, one or more schedulers, and/or one or more communication units of the network node described above in connection with FIG. 2. Additionally or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The transmission component 904 may transmit, via backhaul signaling, information associated with an NES mode of the NES cell. The reception component 902 and/or the transmission component 904 may communicate with a UE via the NES cell in accordance with the NES mode.

The NES mode activation component 908 may activate the NES mode for the NES cell.

The reception component 902 may receive, via backhaul signaling, an acknowledgement of the active NES mode of the NES cell or a rejection of the active NES mode of the NES cell.

The reception component 902 may receive, via backhaul signaling, a request for the NES cell to operate in the NES mode, wherein the information includes an acknowledgment of the request for the NES cell to operate in the NES mode or a rejection of the request for the NES cell to operate in the NES mode.

The reception component 902 may receive, via backhaul signaling, NES configuration information associated with the NES mode.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally or alternatively, a set of (one or more) components shown in FIG. 9 may perform one or more functions described as being performed by another set of components shown in FIG. 9.

FIG. 10 is a diagram of an example apparatus 1000 for wireless communication that supports backhaul signaling to support NES in accordance with the present disclosure. The apparatus 1000 may be a network node associated with an anchor node, or a network node associated with an anchor node may include the apparatus 1000. In some aspects, the apparatus 1000 includes a reception component 1002, a transmission component 1004, and a communication manager 150, which may be in communication with one another (for example, via one or more buses). As shown, the apparatus 1000 may communicate with another apparatus 1006 (such as a UE, a network node, or another wireless communication device) using the reception component 1002 and the transmission component 1004.

In some aspects, the apparatus 1000 may be configured to and/or operable to perform one or more operations described herein in connection with FIGS. 4-6. Additionally or alternatively, the apparatus 1000 may be configured to and/or operable to perform one or more processes described herein, such as process 800 of FIG. 8. In some aspects, the apparatus 1000 may include one or more components of the network node described above in connection with FIG. 2.

The reception component 1002 may receive communications, such as reference signals, control information, and/or data communications, from the apparatus 1006. The reception component 1002 may provide received communications to one or more other components of the apparatus 1000, such as the communication manager 150. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1002 may include one or more antennas, one or more modems, one or more demodulators, one or more MIMO detectors, one or more receive processors, one or more controllers/processors, and/or one or more memories of the network node described above in connection with FIG. 2.

The transmission component 1004 may transmit communications, such as reference signals, control information, and/or data communications, to the apparatus 1006. In some aspects, the communication manager 150 may generate communications and may transmit the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, one or more modems, one or more modulators, one or more transmit MIMO processors, one or more transmit processors, one or more controllers/processors, and/or one or more memories of the network node described above in connection with FIG. 2. In some aspects, the transmission component 1004 may be co-located with the reception component 1002 in one or more transceivers.

The communication manager 150 may receive or may cause the reception component 1002 to receive, via backhaul signaling, information associated with an NES mode of an NES cell. The communication manager 150 may transmit or may cause the transmission component 1004 to transmit, via the anchor cell, assistance information to enable a UE to access the NES cell in accordance with the NES mode. In some aspects, the communication manager 150 may perform one or more operations described elsewhere herein as being performed by one or more components of the communication manager 150.

The communication manager 150 may include one or more controllers/processors, one or more memories, one or more schedulers, and/or one or more communication units of the network node described above in connection with FIG. 2. In some aspects, the communication manager 150 includes a set of components, such as an anchor mode activation component 1008. Alternatively, the set of components may be separate and distinct from the communication manager 150. In some aspects, one or more components of the set of components may include or may be implemented within one or more controllers/processors, one or more memories, one or more schedulers, and/or one or more communication units of the network node described above in connection with FIG. 2. Additionally or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive, via backhaul signaling, information associated with an NES mode of an NES cell. The transmission component 1004 may transmit, via the anchor cell, assistance information to enable a UE to access the NES cell in accordance with the NES mode.

The anchor mode activation component 1008 may activate an anchor mode for the anchor cell.

The transmission component 1004 may transmit, via backhaul signaling, an indication that the anchor cell supports operating in an anchor mode for the NES cell.

The transmission component 1004 may transmit, via backhaul signaling, an acknowledgment of the request for the anchor cell to operate in the anchor mode for the NES cell or a rejection of the request for the anchor cell to operate in the anchor mode for the NES cell.

The transmission component 1004 may transmit, via backhaul signaling, an indication that the anchor cell is operating in an anchor mode for the NES cell, wherein the information includes an acknowledgement of the anchor cell operating in the anchor mode for the NES cell or a rejection of the anchor cell operating in the anchor mode for the NES cell.

The transmission component 1004 may transmit, via backhaul signaling, an indication of an energy cost associated with the anchor cell operating in an anchor mode for the NES cell.

The transmission component 1004 may transmit, via backhaul signaling, NES information indicating at least one of one or more NES cells, including the NES cell, associated with the anchor cell, or a type of NES configuration information for which transmission is supported by the anchor cell.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally or alternatively, a set of (one or more) components shown in FIG. 10 may perform one or more functions described as being performed by another set of components shown in FIG. 10.

The following provides an overview of some Aspects of the present disclosure:

Aspect 1: A method for wireless communication by a network node associated with a network energy saving (NES) cell, comprising: transmitting, via backhaul signaling, information associated with an NES mode of the NES cell; and communicating with a user equipment (UE) via the NES cell in accordance with the NES mode.

Aspect 2: The method of Aspect 1, wherein the information includes an indication that the NES mode is a supported NES mode for the NES cell.

Aspect 3: The method of any of Aspects 1-2, wherein the information includes an indication that the NES mode is an active NES mode of the NES cell.

Aspect 4: The method of Aspect 3, further comprising: receiving, via backhaul signaling, an acknowledgement of the active NES mode of the NES cell or a rejection of the active NES mode of the NES cell.

Aspect 5: The method of any of Aspects 1-4 further comprising: receiving, via backhaul signaling, a request for the NES cell to operate in the NES mode, wherein the information includes an acknowledgment of the request for the NES cell to operate in the NES mode or a rejection of the request for the NES cell to operate in the NES mode.

Aspect 6: The method of any of Aspects 1-5, wherein the information indicates an energy cost associated with the NES cell operating in the NES mode.

Aspect 7: The method of any of Aspects 1-6, wherein the information indicates one or more anchor cells, associated with the NES cell, for the NES mode.

Aspect 8: The method of any of Aspects 1-7, wherein the information includes NES configuration information, associated with the NES mode, to be transmitted via an anchor cell.

Aspect 9: The method of Aspect 8, wherein the NES mode is an on-demand system information block type 1 (SIB1) mode, and wherein the NES configuration information includes: a wake-up-signal (WUS) configuration, and a post-demand SIB 1 transmission configuration associated with the NES cell.

Aspect 10: The method of Aspect 9, wherein communicating with the UE via the NES cell in accordance with the NES mode comprises: receiving a WUS in accordance with the WUS configuration; and transmitting, in connection with receiving the WUS, an SIB1 via the NES cell in accordance with the post-demand SIB 1 transmission configuration.

Aspect 11: The method of any of Aspects 8-10, wherein the NES configuration information includes system information associated with the NES cell.

Aspect 12: The method of any of Aspects 1-11, further comprising: receiving, via backhaul signaling, NES configuration information associated with the NES mode.

Aspect 13: The method of Aspect 12, wherein the NES configuration information indicates at least one of: a system information block type 1 (SIB1) broadcast periodicity associated with a hybrid on-demand SIB1 NES mode, or a post-demand SIB1 transmission configuration associated with an on-demand SIB1 NES mode or the hybrid on-demand SIB1 NES mode.

Aspect 14: The method of any of Aspects 1-13, wherein the information includes beam-specific information associated with the NES mode.

Aspect 15: The method of any of Aspects 1-14, wherein the network node associated with the NES cell is a distributed unit (DU), and wherein transmitting the information associated with the NES mode of the NES cell comprises: transmitting the information associated with the NES mode of the NES cell to a central unit (CU).

Aspect 16: The method of any of Aspects 1-15, wherein transmitting the information associated with the NES mode of the NES cell comprises: transmitting the information associated with the NES mode of the NES cell to another network node associated with an anchor cell.

Aspect 17: The method of any of Aspects 1-16, wherein the backhaul signaling includes signaling via an F1 interface, an Xn interface, an X2 interface, or an application program interface (API).

Aspect 18: A method for wireless communication by a network node associated with an anchor cell, comprising: receiving, via backhaul signaling, information associated with a network energy saving (NES) mode of an NES cell; and transmitting, via the anchor cell, assistance information to enable a user equipment (UE) to access the NES cell in accordance with the NES mode.

Aspect 19: The method of Aspect 18, further comprising: transmitting, via backhaul signaling, an indication that the anchor cell supports operating in an anchor mode for the NES cell.

Aspect 20: The method of any of Aspects 18-19, wherein the information includes a request for the anchor cell to operate in an anchor mode for the NES cell.

Aspect 21: The method of Aspect 20, further comprising: transmitting, via backhaul signaling, an acknowledgment of the request for the anchor cell to operate in the anchor mode for the NES cell or a rejection of the request for the anchor cell to operate in the anchor mode for the NES cell.

Aspect 22: The method of any of Aspects 18-21, further comprising: transmitting, via backhaul signaling, an indication that the anchor cell is operating in an anchor mode for the NES cell, wherein the information includes an acknowledgement of the anchor cell operating in the anchor mode for the NES cell or a rejection of the anchor cell operating in the anchor mode for the NES cell.

Aspect 23: The method of any of Aspects 18-22, further comprising: transmitting, via backhaul signaling, an indication of an energy cost associated with the anchor cell operating in an anchor mode for the NES cell.

Aspect 24: The method of any of Aspects 18-23, wherein the information indicates one or more NES cells, including the NES cell, associated with the anchor cell.

Aspect 25: The method of any of Aspects 18-24, wherein the information includes NES configuration information, associated with the NES mode, for the NES cell, and wherein transmitting the assistance information comprises: transmitting the NES configuration information via the anchor cell.

Aspect 26: The method of Aspect 25, wherein the NES mode is an on-demand system information block type 1 (SIB1) mode, and wherein the NES configuration information includes: a wake-up-signal (WUS) configuration, and a post-demand SIB 1 transmission configuration associated with the NES cell.

Aspect 27: The method of any of Aspects 25-26, wherein the NES configuration information includes system information associated with the NES cell.

Aspect 28: The method of any of Aspects 25-27, wherein the information includes transmission configuration information associated with transmission of the NES configuration information via the anchor cell.

Aspect 29: The method of any of Aspects 18-28, further comprising: transmitting, via backhaul signaling, NES information indicating at least one of: one or more NES cells, including the NES cell, associated with the anchor cell, or a type of NES configuration information for which transmission is supported by the anchor cell.

Aspect 30: The method of any of Aspects 18-29, wherein the information includes beam-specific information associated with the NES mode.

Aspect 31: The method of any of Aspects 18-30, wherein the network node associated with the anchor cell is a distributed unit (DU), and wherein receiving the information associated with the NES mode of the NES cell comprises: receiving the information associated with the NES mode of the NES cell from a central unit (CU).

Aspect 32: The method of any of Aspects 18-31, wherein receiving the information associated with the NES mode of the NES cell comprises: receiving the information associated with the NES mode of the NES cell from another network node associated with the NES cell.

Aspect 33: The method of any of Aspects 18-32, wherein the backhaul signaling includes signaling via an F1 interface, an Xn interface, an X2 interface, or an application program interface (API).

Aspect 34: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-33.

Aspect 35: An apparatus for wireless communication at a device, the apparatus comprising one or more memories and one or more processors coupled to the one or more memories, the one or more processors configured to cause the device to perform the method of one or more of Aspects 1-33.

Aspect 36: An apparatus for wireless communication, the apparatus comprising at least one means for performing the method of one or more of Aspects 1-33.

Aspect 37: A non-transitory computer-readable medium storing code for wireless communication, the code comprising instructions executable by one or more processors to perform the method of one or more of Aspects 1-33.

Aspect 38: A non-transitory computer-readable medium storing a set of instructions for wireless communication, the set of instructions comprising one or more instructions that, when executed by one or more processors of a device, cause the device to perform the method of one or more of Aspects 1-33.

Aspect 39: A device for wireless communication, the device comprising a processing system that includes one or more processors and one or more memories coupled with the one or more processors, the processing system configured to cause the device to perform the method of one or more of Aspects 1-33.

Aspect 40: An apparatus for wireless communication at a device, the apparatus comprising one or more memories and one or more processors coupled to the one or more memories, the one or more processors individually or collectively configured to cause the device to perform the method of one or more of Aspects 1-33.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. A network node for wireless communication, comprising:
a processing system that includes one or more processors and one or more memories coupled with the one or more processors, the processing system configured to cause the network node to:
transmit, via backhaul signaling, information associated with a network energy saving (NES) mode of an NES cell; and
communicate with a user equipment (UE) via the NES cell in accordance with the NES mode.

2. The network node of claim 1, wherein the information includes an indication that the NES mode is a supported NES mode for the NES cell.

3. The network node of claim 1, wherein the information includes an indication that the NES mode is an active NES mode of the NES cell.

4. The network node of claim 1, wherein the processing system is further configured to cause the network node to:
receive, via backhaul signaling, a request for the NES cell to operate in the NES mode, wherein the information includes an acknowledgment of the request for the NES cell to operate in the NES mode or a rejection of the request for the NES cell to operate in the NES mode.

5. The network node of claim 1, wherein the information indicates one or more anchor cells, associated with the NES cell, for the NES mode.

6. The network node of claim 1, wherein the information includes NES configuration information, associated with the NES mode, to be transmitted via an anchor cell.

7. The network node of claim 6, wherein the NES mode is an on-demand system information block type 1 (SIB1) mode, and wherein the NES configuration information includes:
a wake-up-signal (WUS) configuration, and
a post-demand SIB 1 transmission configuration associated with the NES cell.

8. The network node of claim 7, wherein, to cause the network node to communicate with the UE via the NES cell in accordance with the NES mode, the processing system is configured to cause the network node to:
receive a WUS in accordance with the WUS configuration; and
transmit, in connection with receiving the WUS, an SIB1 via the NES cell in accordance with the post-demand SIB1 transmission configuration.

9. The network node of claim 6, wherein the NES configuration information includes system information associated with the NES cell.

10. The network node of claim 1, wherein the information includes beam-specific information associated with the NES mode.

11. A network node for wireless communication, comprising:
a processing system that includes one or more processors and one or more memories coupled with the one or more processors, the processing system configured to cause the network node to:
receive, via backhaul signaling, information associated with a network energy saving (NES) mode of an NES cell; and
transmit, via an anchor cell, assistance information to enable a user equipment (UE) to access the NES cell in accordance with the NES mode.

12. The network node of claim 11, wherein the information includes a request for the anchor cell to operate in an anchor mode for the NES cell.

13. The network node of claim 11, wherein the processing system is further configured to cause the network node to:
transmit, via backhaul signaling, an indication that the anchor cell is operating in an anchor mode for the NES cell, wherein the information includes an acknowledgement of the anchor cell operating in the anchor mode for the NES cell or a rejection of the anchor cell operating in the anchor mode for the NES cell.

14. The network node of claim 11, wherein the information indicates one or more NES cells, including the NES cell, associated with the anchor cell.

15. The network node of claim 11, wherein the information includes NES configuration information, associated with the NES mode, for the NES cell, and wherein, to cause the network node to transmit the assistance information, the processing system is configured to cause the network node to:
transmit the NES configuration information via the anchor cell.

16. The network node of claim 15, wherein the NES mode is an on-demand system information block type 1 (SIB1) mode, and wherein the NES configuration information includes:
a wake-up-signal (WUS) configuration, and
a post-demand SIB 1 transmission configuration associated with the NES cell.

17. The network node of claim 15, wherein the NES configuration information includes system information associated with the NES cell.

18. The network node of claim 15, wherein the information includes transmission configuration information associated with transmission of the NES configuration information via the anchor cell.

19. The network node of claim 11, wherein the information includes beam-specific information associated with the NES mode.

20. A method for wireless communication by a network node associated with a network energy saving (NES) cell, comprising:
transmitting, via backhaul signaling, information associated with an NES mode of the NES cell; and
communicating with a user equipment (UE) via the NES cell in accordance with the NES mode.
